(19) United States
(12) Patent Application Publication
(10) Pub. No.: US 2024/0330681 A1
(43) Pub. Date: Oct. 3, 2024

(54) PROCESSING SYSTEM, INTEGRATED CIRCUIT, AND PRINTED CIRCUIT BOARD FOR OPTIMIZING PARAMETERS OF DEEP NEURAL NETWORK

(71) Applicant: Shanghai Cambricon Information Technology Co., Ltd., Shanghai (CN)

(72) Inventors: Xin YU, Shanghai (CN); Yehao YU, Shanghai (CN); Nan WANG, Shanghai (CN); Yanjun ZHAO, Shanghai (CN); Lingdong WU, Shanghai (CN); Yongwei ZHAO, Shanghai (CN); Yimin ZHUANG, Shanghai (CN); Xiaobing CHEN, Shanghai (CN)

(21) Appl. No.: 18/284,396

(22) PCT Filed: Jun. 7, 2022
(86) PCT No.: PCT/CN2022/097372

§ 371 Date: Apr. 3, 2024

(30) Foreign Application Priority Data
Jun. 8, 2021 (CN) 202110637685.0
Jun. 8, 2021 (CN) 202110637698.8
Jun. 8, 2021 (CN) 202110639072.0
Jun. 8, 2021 (CN) 202110639078.8
Jun. 8, 2021 (CN) 202110639079.2

(51) Int. Cl. G06N 3/08; G06N 5/04

(52) U.S. Cl. CPC G06N 3/08; G06N 5/04

(57) ABSTRACT

A device for optimizing parameters of a deep neural network is included in an integrated circuit apparatus. The integrated circuit apparatus includes a general interconnection interface and other processing apparatus. A computing apparatus interacts with other processing apparatus to jointly complete a computing operation specified by a user. The integrated circuit apparatus further includes a storage apparatus. The storage apparatus is connected to the computing apparatus and other processing apparatus, respectively. The storage apparatus is used for data storage of the computing apparatus and other processing apparatus.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/CN2022/097372 filed on Jun. 7, 2022, which claims priority to the benefit of Chinese Patent Application Nos. 202110637685.0 filed on Jun. 8, 2021, 202110639079.2 filed on Jun. 8, 2021, 202110639072.0 filed on Jun. 8, 2021, 202110637698.8 filed on Jun. 8, 2021, and 202110639078.8 filed on Jun. 8, 2021, in the Chinese Intellectual Property Office, the entire contents of which are incorporated herein by reference.

### BACKGROUND

### 1. Technical Field

The present disclosure generally relates to a neural network field. More specifically, the present disclosure relates to a processing system, integrated circuit, and board card for optimizing parameters of a deep neural network.

### 2. Background Art

With the popularization and development of artificial intelligence technology, deep neural network models tend to be complex, and some models include hundreds of layers of operators, which makes the operation amount rise rapidly.

There are many ways to reduce the operation amount, one of which is quantization. The quantization refers to converting a weight and activation value represented by high-precision floating-point numbers into low-precision integers, which has the advantages of low memory bandwidth, low power consumption, low computing resource occupation, and low model storage requirements.

The quantization is a common way to simplify the amount of data at present, but the quantization operation still lacks hardware support. For the existing accelerators, most of the data is quantized offline, so a general processor is required to assist processing, and the efficiency is not good.

Therefore, highly efficient quantization hardware is urgently required.

### SUMMARY

In order to at least partly solve technical problems mentioned in the background, a solution of the present disclosure provides a processing system, integrated circuit, and board card for optimizing parameters of a deep neural network.

One aspect of the present disclosure discloses a processing system for optimizing parameters of a deep neural network, which includes a near data processing apparatus and an acceleration apparatus. The near data processing apparatus is configured to store and quantize original data running on the deep neural network to generate quantized data. The acceleration apparatus is configured to train the deep neural network based on the quantized data to generate and quantize a training result. The near data processing apparatus is configured to update the parameters based on the quantized training result, and image data infers the deep neural network based on the updated parameters.

Another aspect of the present disclosure discloses an integrated circuit apparatus including the above elements. Moreover, the present disclosure also discloses a board card including the above integrated circuit apparatus.

The present disclosure realizes the quantization of online dynamic statistics, reduces unnecessary data access, and achieves the technical effect of high-precision parameter update, which makes the neural network model more accurate and lighter. Moreover, data may be directly quantized on the memory, and an error caused by quantizing long-tail distributed data may be suppressed.

### BRIEF DESCRIPTION OF THE DRAWINGS

By reading the following detailed description with reference to drawings, the above and other objects, features and technical effects of exemplary implementations of the present disclosure will become easier to understand. In the drawings, several implementations of the present disclosure are shown in an exemplary manner rather than a restrictive manner, and the same or corresponding reference numerals indicate the same or corresponding parts.

FIG. 1 is a structural diagram of a board card according to an embodiment of the present disclosure.

FIG. 2 is a structural diagram of an integrated circuit apparatus according to an embodiment of the present disclosure.

FIG. 3 is a schematic diagram of an internal structure of a computing apparatus according to an embodiment of the present disclosure.

FIG. 4 is a schematic diagram of an internal structure of a processor core according to an embodiment of the present disclosure.

FIG. 5 is a schematic diagram showing that a processor core intends to write data to a processor core of another cluster.

FIG. 6 is a schematic diagram of hardware related to a quantization operation according to an embodiment of the present disclosure.

FIG. 7 is a schematic diagram of a statistic quantization unit according to an embodiment of the present disclosure.

FIG. 8 is a schematic diagram of a quantization buffer controller and a cache array according to an embodiment of the present disclosure.

FIG. 9 is a schematic diagram of a near data processing apparatus according to an embodiment of the present disclosure.

FIG. 10 is a schematic diagram of an optimizer according to an embodiment of the present disclosure.

FIG. 11 is a flowchart of a method for quantizing original data according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those of ordinary skill in the art based on the embodiments of the present disclosure without creative efforts shall fall within the protection scope of the present disclosure.

It should be understood that terms such as “first”, “second”, “third”, and “fourth” in the claims, the specification, and the drawings of the present disclosure are used for distinguishing different objects rather than describing a specific order. Terms such as “including” and “comprising” used in the specification and the claims of the present disclosure indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims of the present disclosure refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context.

Specific implementations of the present disclosure will be described in detail in combination with drawings below.

Deep learning has been proven to work well on tasks including image classification, object detection, natural language processing, and the like. A large number of applications today are equipped with image (computer vision)-related deep learning algorithms.

Deep learning is generally implemented using a neural network model. As model predictions become more accurate and networks become deeper, memory capacity and memory bandwidth required to run neural networks are quite large, making devices pay a high price to become intelligent.

In practice, developers compress and encode data to reduce network size, and quantization is one of the most widely used compression methods. The quantization refers to converting high-precision floating-point data (such as FP32) into low-precision fixed-point data (INT8). A high-precision floating-point number requires more bits for description, while a low-precision fixed-point number requires fewer bits for full description. By reducing the number of bits of data, the burden of an intelligent device is effectively released.

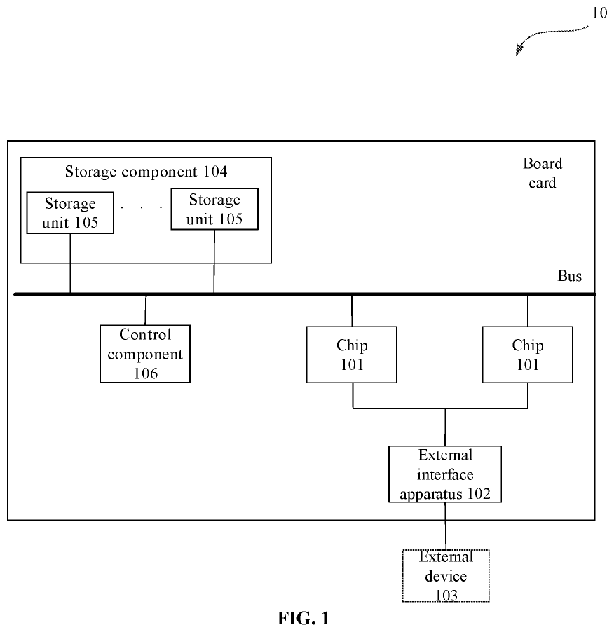

FIG. 1 is a schematic structural diagram of a board card 10 according to an embodiment of the present disclosure. As shown in FIG. 1, the board card 10 includes a chip 101, which is a system on chip (SoC), or called an on-chip system, and integrates one or a plurality of combined processing apparatuses. The combined processing apparatus is an artificial intelligence operation unit, which may support various types of deep learning and machine learning algorithms using quantization optimization and meet requirements of intelligent processing in complex scenarios in computer vision, speech, natural language processing, data mining, and other fields. In particular, deep learning technology is widely used in the field of cloud intelligence. A notable feature of cloud intelligence applications is the large amount of input data, which has high requirements for storage capacity and computing power of a platform. The board card 10 of this embodiment is suitable for the cloud intelligent applications and has huge off-chip storage, huge on-chip storage, and great computing power.

The chip 101 is connected to an external device 103 through an external interface apparatus 102. The external device 103 may be, for example, a server, a computer, a camera, a monitor, a mouse, a keyboard, a network card, or a WIFI interface. To-be-processed data may be transferred from the external device 103 to the chip 101 through the external interface apparatus 102. A computing result of the chip 101 may be transferred back to the external device 103 through the external interface apparatus 102. According to different application scenarios, the external interface apparatus 102 may have different interface forms, such as a peripheral component interface express (PCIe) interface, and the like.

The board card 10 further includes a storage component 104 configured to store data. The storage component 104 includes one or a plurality of storage elements 105. The storage component 104 is connected to and transfers data to a control component 106 and the chip 101 through a bus. The control component 106 in the board card 10 is configured to regulate and control a state of the chip 101. As such, in an application scenario, the control component 106 may include a micro controller unit (MCU).

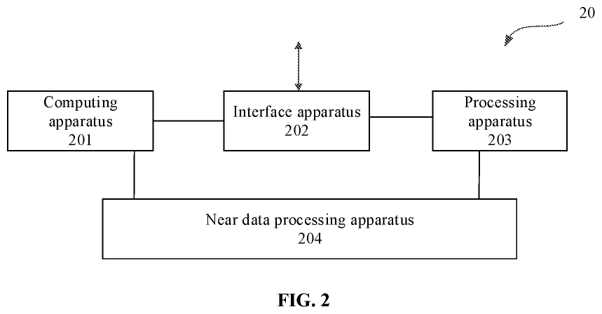

FIG. 2 is a structural diagram of a combined processing apparatus in the chip 101 of this embodiment. As shown in FIG. 2, a combined processing apparatus 20 includes a computing apparatus 201, an interface apparatus 202, a processing apparatus 203, and a near data processing apparatus 204.

The computing apparatus 201 is configured to perform an operation specified by a user. The computing apparatus 201 is mainly implemented as a single-core intelligent processor or a multi-core intelligent processor and is configured to perform deep learning computing or machine learning computing. The computing apparatus 201 interacts with the processing apparatus 203 through the interface apparatus 202 to jointly complete the operation specified by the user.

The interface apparatus 202 is configured to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general processing apparatus and performs basic controls, including but not limited to, moving data, starting and/or stopping the computing apparatus 201. According to different implementations, the processing apparatus 203 may be a central processing unit (CPU), a graphics processing unit (GPU), or one or more of other general and/or dedicated processors. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, the number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when considered together, the computing apparatus 201 and the processing apparatus 203 are viewed as forming a heterogeneous multi-core structure.

The near data processing apparatus 204 is a memory with processing power and is configured to store to-be-processed data. A size of the memory is 16 G or more than 16G generally. The near data processing apparatus 204 is configured to save data of the computing apparatus 201 and/or the processing apparatus 203.

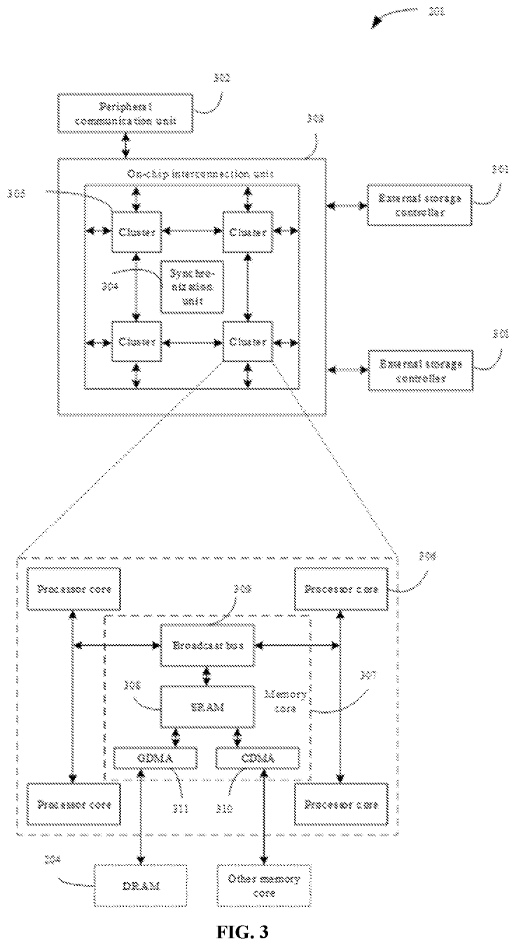

FIG. 3 is a schematic diagram of an internal structure of the computing apparatus 201. The computing apparatus 201 is used for processing input data in computer vision, speech, natural language, and data mining. The computing apparatus 201 in the figure is designed in a multi-core hierarchical structure. The computing apparatus 201 serves as an on-chip system and includes a plurality of clusters, where each cluster further includes a plurality of processor cores. In other words, the computing apparatus 201 is composed of a hierarchy of on-chip system-cluster-processor core.

In terms of a hierarchy of the on-chip system, as shown in FIG. 3, the computing apparatus 201 includes an external storage controller 301, a peripheral communication unit 302, an on-chip interconnection unit 303, a synchronization unit 304, and a plurality of clusters 305.

There may be a plurality of external storage controllers 301, two of which are illustrated in the figure. The external storage controllers are configured to, in response to access requests from the processor cores, access an external storage device, such as the near data processing apparatus 204 in FIG. 2, thereby reading data from off-chip or writing the data to off-chip. The peripheral communication unit 302 is configured to receive a control signal from the processing apparatus 203 through the interface apparatus 202 to start the computing apparatus 201 to perform a task. The on-chip interconnection unit 303 connects the external storage controller 301, the peripheral communication unit 302, and the plurality of clusters 305 and is configured to transfer data and control signals among the units. The synchronization unit 304 is a global barrier controller (GBC) and is configured to coordinate a work progress of each cluster to ensure synchronization of information. The plurality of clusters 305 are computing cores of the computing apparatus 201, four of which are illustrated in the figure. With the development of hardware, the computing apparatus 201 of the present disclosure may further include 8, 16, 64, or even more clusters 305. The clusters 305 are used for efficiently performing deep learning algorithms.

In terms of a hierarchy of clusters, as shown in FIG. 3, each cluster 305 includes a plurality of processor cores (intelligent processing unit (IPU) cores) 306 and a memory core (MEM core) 307.

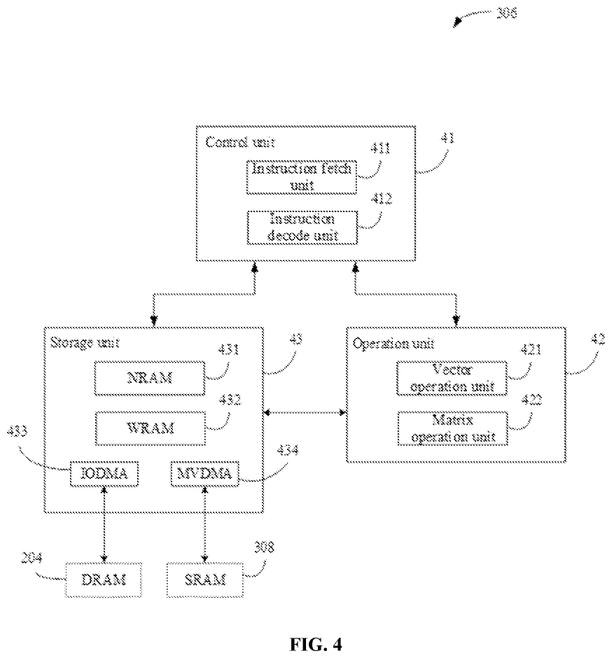

Four processor cores 306 are illustrated in the figure. The present disclosure does not limit the number of the processor cores 306. An internal architecture of the processor core 406 is shown in FIG. 4. Each processor core 306 includes three units: a control unit 41, an operation unit 42, and a storage unit 43.

The control unit 41 is configured to coordinate and control work of the operation unit 42 and the storage unit 43 to complete a deep learning task. The control unit 31 includes an instruction fetch unit (IFU) 411 and an instruction decode unit (IDU) 412. The IFU 411 is configured to acquire an instruction from the processing apparatus 203. The IDU 412 is configured to decode the instruction acquired and send a decoding result as control information to the operation unit 42 and the storage unit 43.

The operation unit 42 includes a vector operation unit 421 and a matrix operation unit 422. The vector operation unit 421 is configured to perform a vector operation and supports complex operations, such as vector multiplication, addition, and nonlinear conversion. The matrix operation unit 422 is responsible for core computing of deep learning algorithms, which includes matrix multiplication and convolution.

The storage unit 43 is configured to store or move related data. The storage unit 43 includes a neuron cache element (neuron random access memory (RAM), NRAM) 431, a weight cache element (weight RAM, WRAM) 432, an input/output direct memory access (IODMA) unit 433, and a move direct memory access (MVDMA) unit 434. The NRAM 431 is configured to store a feature map for computing by the processor cores 306 and an intermediate result after the computing. The WRAM 432 is configured to store a weight of a deep learning network. The IODMA 433 controls memory accesses of the NRAM 431/the WRAM 432 and the near data processing apparatus 204 through a broadcast bus 309. The MVDMA 434 is configured to control memory accesses of the NRAM 431/the WRAM 432 and a shared cache element (SRAM) 308.

Going back to FIG. 3, the memory core 307 is mainly used for storage and communication. In other words, the memory core 307 is mainly configured to store shared data or intermediate results between the processor cores 306 and perform communication between the clusters 305 and the near data processing apparatus 204, communication between the clusters 305, and communication between the processor cores 306. In other embodiments, the memory core 307 is capable of performing a scalar operation and is used for performing the scalar operation.

The memory core 307 includes the SRAM 308, the broadcast bus 309, a cluster direct memory access (CDMA) unit 310, and a global direct memory access (GDMA) unit 311. The SRAM 308 plays the role of a data transfer station with high performance. Data reused among different processor cores 306 in the same cluster 305 is not required to be acquired from the near data processing apparatus 204 separately through the processor cores 306. Instead, the data is transferred among the processor cores 306 through the SRAM 308. The memory core 307 is only required to quickly distribute the reused data from the SRAM 308 to the plurality of processor cores 306 to improve inter-core communication efficiency and greatly reduce on-chip and off-chip input/output accesses.

The broadcast bus 309, the CDMA 310, and the GDMA 311 are configured to perform the communication between the processor cores 306, the communication between the clusters 305, and data transfer between the clusters 305 and the near data processing apparatus 204, respectively. The above will be explained separately below.

The broadcast bus 309 is used for completing high-speed communication between the processor cores 306 in the clusters 305. The broadcast bus 309 of this embodiment supports inter-core communication modes including unicast, multicast, and broadcast. The unicast refers to point-to-point (single processor core-to-single processor core) data transfer. The multicast refers to a communication mode for transferring one copy of data from the SRAM 308 to a certain number of processor cores 306. The broadcast refers to a communication mode for transferring one copy of data from the SRAM 308 to all processor cores 306. The broadcast is a special case of the multicast.

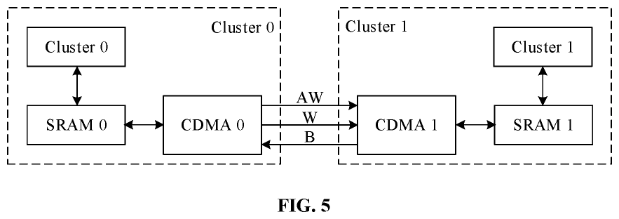

The CDMA 310 is configured to control memory access of the SRAM 308 among different clusters 305 in the same computing apparatus 201. FIG. 5 is a schematic diagram showing that a processor core intends to write data to a processor core of another cluster to illustrate a working principle of the CDMA 310. In this application scenario, the same computing apparatus includes a plurality of clusters. For the convenience of illustration, only a cluster 0 and a cluster 1 are shown in the figure. The cluster 0 and the cluster 1 include a plurality of processor cores, respectively. Similarly, for the convenience of illustration, the cluster 0 in the figure shows only a processor core 0, and the cluster 1 in the figure shows only a processor core 1. The processor core 0 intends to write data to the processor core 1.

First, the processor core 0 sends a unicast write request to write the data to a local SRAM 0. A CDMA 0 serves as a master terminal, and a CDMA 1 serves as a slave terminal. The master terminal sends the write request to the slave terminal. In other words, the master terminal sends a write address AW and write data W and sends the data to an SRAM 1 of the cluster 1. Next, the slave terminal sends a write response B in response. Finally, the processor core 1 of the cluster 1 sends a unicast read request to read the data from the SRAM 1.

Going back to FIG. 3, the GDMA 311 works with the external storage controller 301 and is configured to control memory accesses from the SRAM 308 to the near data processing apparatus 204 in the clusters 305, or read the data from the near data processing apparatus 204 to the SRAM 308 in the clusters 305. It may be known from the above that communication between the near data processing apparatus 204 and the NRAM 431 or the WRAM 432 may be implemented through two channels. A first channel is to directly contact the near data processing apparatus 204 with the NRAM 431 or the WRAM 432 through the IODAM 433. A second channel is to transfer the data between the near data processing apparatus 204 and the SRAM 308 through the GDMA 311 first, and then to transfer the data between the SRAM 308 and the NRAM 431 or the WRAM 432 through the MVDMA 434. Although it seems that the second channel requires more elements and has long data flows, in fact, in some embodiments, the bandwidth of the second channel is much greater than that of the first channel. Therefore, the communication between the near data processing apparatus 204 and the NRAM 431 or the WRAM 432 may be more efficient through the second channel. The embodiment of the present disclosure may select a data transfer channel according to hardware conditions.

In other embodiments, a function of the GDMA 311 and a function of the IODMA 433 may be integrated in the same component. For the convenience of description, the GDMA 311 and the IODMA 433 are viewed as different components in the present disclosure. For those skilled in the art, as long as functions and technical effects realized by the GDMA 311 and the IODMA 433 are similar to those of the present disclosure, the GDMA 311 and the IODMA 433 shall fall within the scope of protection of the present disclosure. Further, the function of the GDMA 311, the function of the IODMA 433, a function of the CDMA 310, and a function of the MVDMA 434 may also be implemented by the same component.

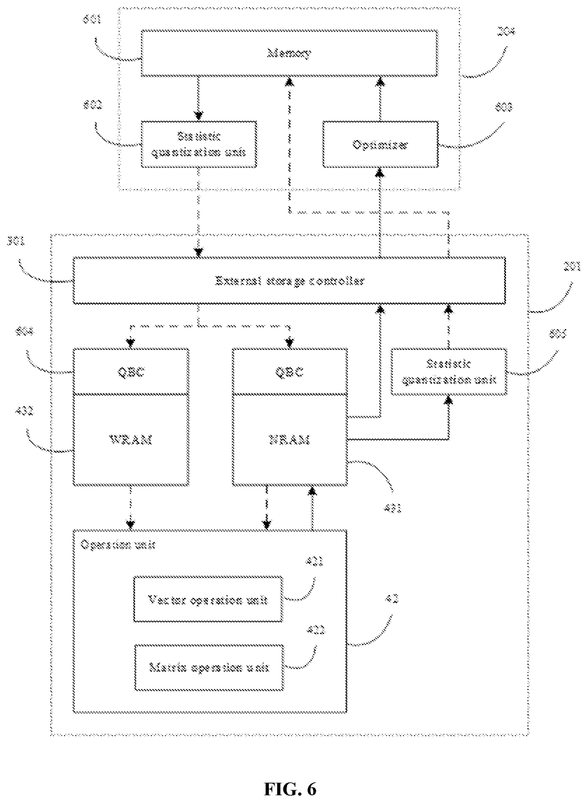

For the convenience of illustration, hardware related to a quantization operation shown in FIG. 1 to FIG. 4 is integrated as shown in FIG. 6. This processing system may optimize parameters of a deep neural network during a training process and include a near data processing apparatus 204 and a computing apparatus 201. The near data processing apparatus 204 is configured to store and quantize original data running on the deep neural network to generate quantized data. The computing apparatus 201 is an acceleration apparatus configured to train the deep neural network based on the quantized data to generate and quantize a training result. The near data processing apparatus 204 is configured to update the parameters based on the quantized training result, and all kinds of data are based on the updated parameters and the trained deep neural network is run by the computing apparatus 201 to obtain a computing result (prediction result).

As mentioned above, the near data processing apparatus 204 not only has memory capability, but also has basic operation capability. As shown in FIG. 6, the near data processing apparatus 204 includes a memory 601, a statistic quantization unit (SQU) 602, and an optimizer 603.

The memory 601 may be any appropriate storage medium (including a magnetic storage medium or a magneto-optical storage medium, and the like), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), a read only memory (ROM), and a random access memory (RAM), and the like. Input data required to run a deep neural network is stored in the memory 601.

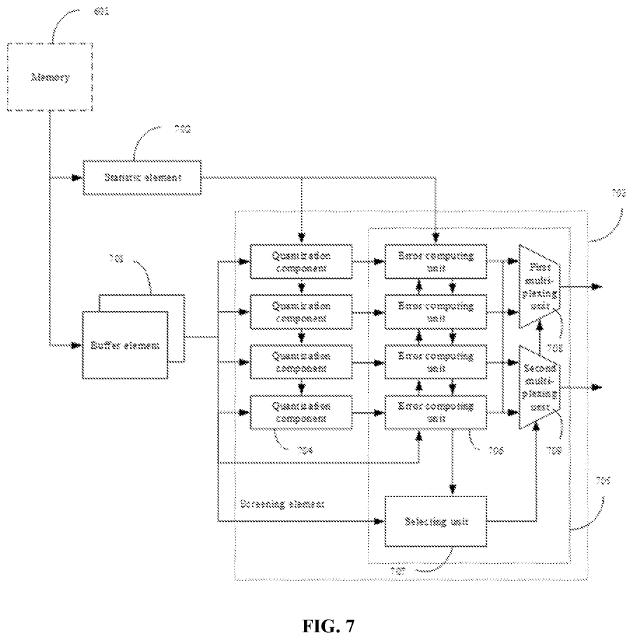

The statistic quantization unit 602 is configured to quantize the input data. FIG. 7 is a schematic diagram of the statistic quantization unit 602 of this embodiment. The statistic quantization unit 602 includes a buffer element 701, a statistic element 702, and a screening element 703.

The buffer element 701 is configured to temporarily store a plurality of pieces of input data from the memory 601. When the deep neural network model is in the training stage, the input data here refers to original data for training, such as a weight, bias, or other parameters used for training. After the training of the deep neural network model is completed, the input data here refers to a training result, which is the updated weight, bias, or other parameters, and the like, and the trained deep neural network model is obtained, where the trained deep neural network model is used for inference.

The buffer element 701 includes a plurality of buffer components. For illustrative purposes, a first buffer component and a second buffer component are used as examples. The plurality of pieces of input data from the memory 601 are first temporarily stored in sequence to the first buffer component, and when the space of the first buffer component is filled, the buffer element 701 switches, so that subsequent input data is temporarily stored in sequence to the second buffer component. While the input data is temporarily stored in sequence to the second buffer component, the screening element 703 reads the input data temporarily stored in the first buffer component. When the space of the second buffer component is filled, the buffer element 701 switches again, so that the subsequent input data is temporarily stored in sequence to the first buffer component to overwrite the input data originally stored in the first buffer component. Since the screening element 703 has already read the input data originally temporarily stored in the first buffer component, at this time, overwriting the input data originally stored in the first buffer component does not cause a data access error. This embodiment may speed up data access by repeatedly writing and reading input data alternately and synchronously between the first and second buffer components. Specifically, in this embodiment, a size of each buffer component is 4 KB. The size of the buffer component in this embodiment is only an example and may be planned according to actual situations.

The statistic element 702 is configured to generate a statistic parameter according to the plurality of pieces of input data from the memory 601. In this embodiment, quantization is performed based on statistic quantization. The statistic quantization has been widely used in the deep neural network and is required to compute a statistic parameter according to quantitative historical data. Several statistic quantization methods are described below.

A first statistic quantification method is disclosed in N. Wang, J. Choi, D. Brand, C. Chen, and K. Gopalakrishnan, Training deep neural networks with 8-bit floating point numbers in NeurIPS, 2018. This method may quantize input data into FP8 intermediate data, and a statistic parameter required in this method is a maximum value of an absolute value of input data x (max|x|).

A second statistic quantification method is disclosed in Y. Yang, S. Wu, L. Deng, T. Yan, Y. Xie, and G. Li, Training high-performance and large-scale deep neural networks with full 8-bit integers in Neural Networks, 2020. This method may quantize input data into INT8 intermediate data, and a statistic parameter required in this method is a maximum value of an absolute value of input data x (max|x|).

A third statistic quantification method is disclosed in X. Zhang, S. Liu, R. Zhang, C. Liu, D. Huang, S. Zhou, J. Guo, Y. Kang, Q. Guo, Z. Du et al., Fixed-point back-propagation training in CVPR, 2020. This method estimates a quantization error value between INT8 and INT16 using a dynamically selected data format as needed to cover different distributions. This method quantizes input data into INT8 or INT16 intermediate data, and statistic parameters required in this method are a maximum value (max|x|) of an absolute value of input data x and a mean distance (x-x′) between the input data x and corresponding intermediate data x′.

A fourth statistic quantification method is disclosed in K. Zhong, T. Zhao, X. Ning, S. Zeng, K. Guo, Y. Wang, and H. Yang, Towards lower bit multiplication for convolutional neural network training arXiv preprint arXiv:2006.02804, 2020. This method shows a shiftable fixed-point data format, which is to encode two pieces of data with different fixed-point ranges and an additional bit and then cover representable ranges and resolutions. This method quantizes input data into adjustable INT8 intermediate data, and a statistic parameter required in this method is a maximum value (max|x|) of an absolute value of input data x.

A fifth statistic quantification method is disclosed in Zhu, R. Gong, F. Yu, X. Liu, Y. Wang, Z. Li, X. Yang, and J. Yan, Towards unified int8 training for convolutional neural network arXiv preprint arXiv: 1912.12607, 2019. This method clips long-tail data in a plurality of pieces of input data with minimal precision penalty and then quantizes input data into INT8 intermediate data, and statistic parameters required in this method are a maximum value (max|x|) of an absolute value of input data x and a cosine distance (cos(x, x′)) between the input data x and corresponding intermediate data x′.

To achieve at least the statistic quantification methods disclosed in the preceding literature, the statistic element 702 may be a processor or application specific integrated circuit (ASIC) logic circuit with basic computing power for generating statistic parameters, such as a maximum value (max|x|) of an absolute value of input data x, a cosine distance (cos(x, x′)) between input data x and corresponding intermediate data x′, and a mean distance (x̅-x̅′) between input data x and corresponding intermediate data

As mentioned above, performing the statistic quantization method requires performing global statistics on all input data before quantization to obtain statistic parameters, and performing the global statistics requires moving all input data, which extremely consumes hardware resources and makes the global statistics become a bottleneck in the training process. The statistic element 702 of this embodiment may be set directly in the memory 601 and not in the computing apparatus 201. As such, global statistics and quantization may be performed locally in the memory, which eliminates the procedure of moving all the input data from the memory 601 to the computing apparatus 201 and greatly relieves the capacity and bandwidth pressure of the hardware.

The screening element 703 is configured to read input data one by one from a buffer component of the buffer element 701 according to a statistic parameter to generate output data, where the output data is a result after the input data is quantized, which is quantized data. As shown in FIG. 7, the screening element 703 includes a plurality of quantization components 704 and an error multiplexing component 705.

The quantization components 704 receive input data from the buffer component of the buffer element 701 and quantize the input data (also known as original data) based on different quantization formats. More specifically, by sorting out the above statistic quantization methods, several quantization operations may be classified. Each quantization component 704 performs a different quantization operation and obtains different intermediate data according to a statistic parameter max|x|: in other words, quantization formats of the quantization components 704 implement the above statistic quantization methods. Four quantization components 704 are shown in the figure, which represent that the above statistic quantization methods may be classified into four quantization operations, where each quantization component 704 performs one quantization operation. In this embodiment, these quantization operations differ in the clipping amount of input data, which means that each quantization format corresponds to a different clipping amount of the input data. For example, a quantization operation uses 95% of all input data, another quantization operation uses 60% of all input data. These clipping amounts are determined by the above statistic quantification methods. Once the statistic quantization method is selected, the quantization component 704 must also be adjusted accordingly.

Based on different statistic quantization methods, the screening element 703 chooses to execute corresponding single or a plurality of quantization components 704 to obtain intermediate data after quantization. For example, the first statistic quantization method is only required to use one quantization component 704 to perform one quantization operation, while the second statistic quantization method is required to use all quantization components 704 to perform four quantization operations. These quantization components 704 may perform their own quantization format operations simultaneously or implement a quantization format operation of each quantization component 704 one by one in a time-sharing manner.

The error multiplexing component 705 is configured to determine corresponding errors according to intermediate data and input data and select one of a plurality of pieces of intermediate data as output data: in other words, the error multiplexing component 705 determines quantized data according to these errors. The error multiplexing component 705 includes a plurality of error computing units 706, a selecting unit 707, a first multiplexing unit 708, and a second multiplexing unit 709.

The plurality of error computing units 706 receive input data, intermediate data, and a statistic parameter, and compute error values between the input data and the intermediate data. More specifically, each error computing unit corresponds to one quantization component 704. Intermediate data generated by the quantization component 704 is output to a corresponding error computing unit 706, and the error computing unit 706 computes an error value between the intermediate data generated by the corresponding quantization component 704 and the input data. This error value represents a difference between quantized data generated by the quantization component 704 and input data before quantization, and the difference is compared with a statistic parameter cos(x, x′) from the statistic element 702 or x-x′. In addition to generating the error value, the error computing unit 706 also generates a label to record a quantization format of the corresponding quantization component 704; in other words, the label records that the error value is generated according to the kind of the quantization format.

The selecting unit 707 receives error values of all error computing units 706, selects the smallest of these error values by comparing these error values with input data, and generates a control signal corresponding to intermediate data with the smallest error value.

The first multiplexing unit 708 is configured to output the intermediate data with the smallest error value as output data according to the control signal; in other words, the control signal controls the first multiplexing unit 708 to output the intermediate data with the smallest error value in several quantization formats as the output data, which is quantized data.

The second multiplexing unit 709 is configured to output a label of the intermediate data with the smallest error value according to the control signal, where the label records a quantization format of the output data (quantized data).

Arrows in FIG. 6 represent data flows. To distinguish a difference between unquantized data and quantized data, the unquantized data is represented by a solid arrow, and the quantized data is represented by a dotted arrow. For example, input data transferred from the memory 601 to the statistic quantization unit 602 is original unquantized data, so its data flow is represented by a solid arrow, while output data from the statistic quantization unit 602 is quantized data, so its data flow is represented by a dotted arrow. A data flow of the label is omitted in the figure.

To sum up, according to input data stored in the memory 601, after quantization computing and selection by the statistic quantization unit 602, the near data processing apparatus 204 obtains quantized data with the smallest error value as output data and a label that records a quantization format of the output data.

Continuing to refer to FIG. 6, the computing apparatus of this embodiment includes a direct memory access, a quantization buffer controller (QBC) 604, and a cache array. The direct memory access refers to an external storage controller 301, which is responsible for controlling data move between the computing apparatus 201 and the near data processing apparatus 204. For example, the output data and label of the near data processing apparatus 204 are moved to the cache array of the computing apparatus 201. The cache array includes the NRAM 431 and the WRAM 432.

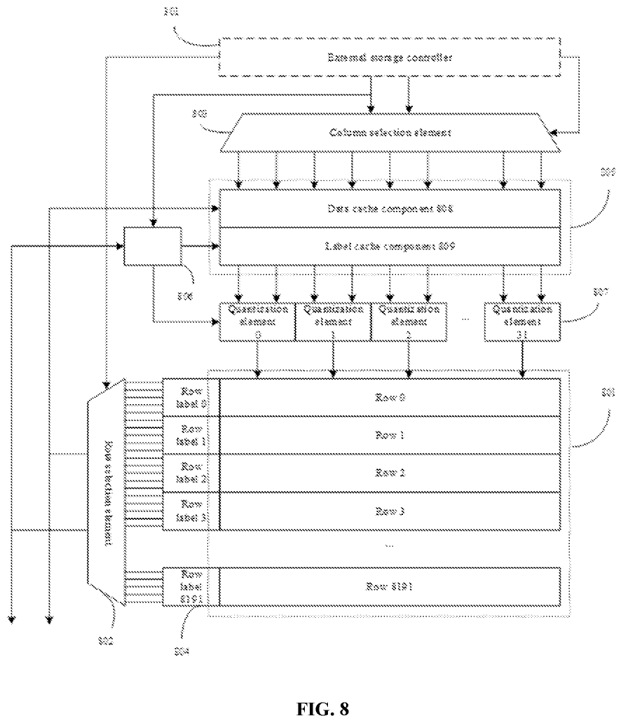

FIG. 8 is a schematic diagram of the quantization buffer controller 604 and a cache array 801. The quantization buffer controller 604 is configured to temporarily store output data and a label sent by the external storage controller 301 and control the output data and label to be stored to appropriate positions of the cache array 801. The cache array 801 may be an existing or customized storage space, which includes a plurality of cache elements, where these cache elements form an array in physical structure, and each cache element may be represented by a row and column of the array. Further, the cache array 801 is controlled by a row selection element 802 and a column selection element 803.

When a cache element in a row i and column j of the cache array 801 is required to be accessed, the external storage controller 301 sends a row selection signal to the row selection element 802 and a column selection signal to the column selection element 803. The row selection element 802 and the column selection element 803 enable the cache array 801 based on the row selection signal and the column selection signal, which enables the quantization element 807 to read data stored in the cache element in the row i and column j of the cache array 801 or write the data to the cache element in the row i and column j of the cache array 801. In this embodiment, since a quantization format of each piece of quantized data is not necessarily the same, in order to facilitate storage and management, data in the same row of the cache array 801 may only be in the same quantization format, but data in different quantization formats may be stored in different rows.

The quantization buffer controller 604 includes a label cache 804, a quantized data cache element 805, a priority cache element 806, and a quantization element 807.

The label cache 804 is configured to store a row label, where the row label records a quantization format of this row of the cache array 801. As mentioned above, the data in the same quantization format is stored in the same row of the cache array 801, but the data in the same quantization format is not necessary to be stored between rows. The label cache 804 is configured to record a quantization format of each row. Specifically, a count of label caches 804 is the same as a row count of the cache array 801. Each label cache 804 corresponds to one row of the cache array 801: in other words, an i-th label cache 804 records a quantization format of an i-th row of the cache array 801.

The quantized data cache element 805 includes a data cache component 808 and a label cache component 809. The data cache component 808 is configured to temporarily store quantized data sent by the external storage controller 301, and the label cache component 809 is configured to temporarily store a label sent by the external storage controller 301. When this piece of quantized data is to be stored to the cache element in the row i and column j of the cache array 801, the external storage controller 301 sends a priority label to the priority cache element 806, where the priority label is used to indicate that this access should be processed based on a specific quantization format, and at the same time, the external storage controller 301 sends a row selection signal to the row selection element 802. In response to the row selection signal, the row selection element 802 retrieves a row label of the row i and sends the row label to the priority cache element 806.

If the priority cache element 806 judges that the priority label is consistent with the row label, it is represented that this access is processed in the quantization format of the row i, and the quantization element 807 ensures that the quantization format of the quantized data is consistent with the quantization format of the row i.

If the priority label is not consistent with the row label, the priority label prevails: in other words, this access is processed in the quantization format recorded by the priority label. The quantization element 807 not only ensures that the quantization format of the quantized data is consistent with the quantization format recorded by the priority label, but also adjusts a quantization format of data originally stored in the row i, so that the quantization format of the quantized data in the entire row is the specific quantization format recorded by the priority label.

More specifically, the priority cache element 806 judges whether the label of the quantized data is the same as the priority label. If the label of the quantized data is the same as the priority label, it is represented that a quantization format of to-be-stored quantized data is consistent with the quantization format of the priority label, and the quantized data is not required to be adjusted. The priority cache element 806 further judges whether the row label is the same as the priority label. If the row label is the same as the priority label, quantized data that has been stored in the row i is not required to be adjusted, the row selection element 802 opens a channel on the row i of the cache array 801, and a quantization element 807 in the column j stores the quantized data to the cache element in the row i and column j. If the row label is not the same as the priority label, the priority cache element 806 controls all quantization elements 807 and converts a quantization format of each piece of quantized data in the row i into the quantization format of the priority label. The row selection element 802 opens the channel on the row i of the cache array 801, and the quantization element 807 stores the quantized data after the format conversion to the cache element in the row i.

If the priority cache element 806 judges that the label of the quantized data is not consistent with the priority label, the quantized data requires format conversion, and the priority cache element 806 further judges whether the row label is the same as the priority label. If the row label is the same as the priority label, the quantized data that has been stored in the row i is not required to be adjusted, and only quantized data from the external storage controller 301 requires format conversion. The priority cache element 806 controls the quantization element 807 in the column j to perform format conversion on the quantized data from the external storage controller 301 to make the quantized data have the quantization format of the priority label. The row selection element 802 opens the channel on the row i of the cache array 801, and the quantization element 807 in the column j stores the converted quantized data to the cache element in the row i and column j. If the priority cache element 806 judges that the row label is not the same as the priority label, the priority cache element 806 controls all the quantization elements 807 and converts the quantization format of each piece of quantized data in the row i into the quantization format of the priority label. The row selection element 802 opens the channel on the row i of the cache array 801, and the quantization element 807 stores the quantized data after the format conversion to the cache element in the row i.

In this embodiment, there are a plurality of quantization elements 807, whose space size and number match a length of the quantized data and a row length of the cache array 801. More specifically, the cache array 801 consists of MxN cache elements: in other words, the cache array 801 has M rows and N columns. Assuming that the length of the quantized data is fixed to S bits, then a length of each cache element is also S bits, and a length of each row is equal to NxS. When a corresponding cache array 801 has N columns, there are N quantization elements 807, where each column corresponds to one quantization element 807. Specifically, in this embodiment, the cache array consists of 8092×32 cache elements: in other words, the cache array has 8092 rows (0th-8191st rows in the figure) and 32 columns, and correspondingly, there are 32 quantization elements 807 (quantization elements 0-31 in the figure). However, the length of the quantized data, the space of the quantization element 807, and the space of the cache element are set to 8 bits, and the length of each row is 32×8 bits.

At this point, the quantization buffer controller 604 is able to store the quantized data to the preset cache element of the NRAM 431 or the WRAM 432 and ensure that the quantization format of the quantized data is consistent with the quantization format stored to a specific row in the NRAM 431 or the WRAM 432.

Going back to FIG. 6, data stored in the cache array (the NRAM 431 and/or the WRAM 432) has been quantized, and when a vector operation is required to be performed, quantized data stored in the NRAM 431 is fetched and output to the vector operation unit 421 in the operation unit 42 for the vector operation. When matrix multiplication and convolution operations are required to be performed, quantized data stored in the NRAM 431 and a weight stored in the WRAM 432 are fetched and output to the matrix operation unit 422 in the operation unit 42 for matrix operations. A computing result is stored back in the NRAM 431. In other embodiments, the computing apparatus 201 may include a computing result cache element. A computing result generated by the operation unit 42 is not stored back in the NRAM 431 but is stored in the computing result cache element.

During the inference phase of the neural network, a computing result is generated after prediction. Since the computing result is non-quantized data, direct processing will occupy too many resources, and further quantization is also required. Therefore, the computing apparatus 201 also includes a statistic quantization unit 605, which has the same structure as the statistic quantization unit 602 and is configured to quantize the computing result to obtain the quantized computing result. The quantized computing result is sent to the memory 601 via the external storage controller 301 for storage.

If it is during the training phase of the neural network, computing results are gradients of weights, and these gradients are required to be transferred back to the near data processing apparatus 204 to update parameters. Although the gradient is also non-quantized data, the gradient is unable to be quantized, and once quantized, the gradient information is lost and is unable to be used to update the parameters. In this situation, the external storage controller 301 takes the gradient directly from the NRAM 431 and sends the gradient to the near data processing apparatus 204.

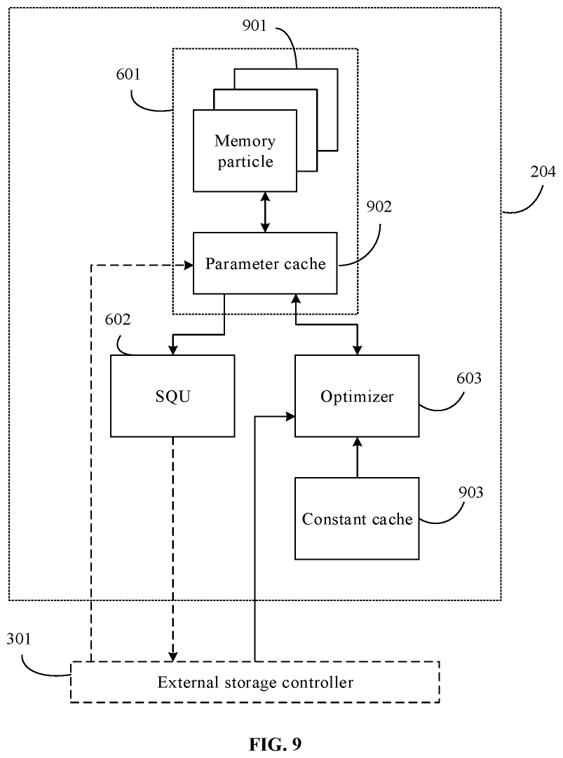

FIG. 9 is a more detailed schematic diagram of the near data processing apparatus 204. The memory 601 consists of a plurality of memory particles 901 and a parameter cache 902. The plurality of memory particles 901 constitutes a storage unit of the memory 601 and is configured to store parameters required to run a neural network. The parameter cache 902 is configured to read and cache the parameters from the plurality of memory particles 901. When each device wants to access the memory 601, the device is required to move data of the memory particles 901 through the parameter cache 902. The parameters referred to here are values that may be continuously updated to optimize the neural network model while training the neural network, such as weights and biases. The optimizer 603 is configured to read parameters from the parameter cache 902 and update the parameters according to a training result (which is the above gradient) sent by the external storage controller 301.

The near data processing apparatus 204 further includes a constant cache 903, where the constant cache 903 is configured to store constants associated with the neural network, such as hyperparameters, so that the optimizer 603 performs various operations based on these constants to update the parameters. The hyperparameters are generally variables set based on the experience of the developer, and will not automatically update their values with training. The learning rate, attenuation rate, number of iterations, number of layers of the neural network, and number of neurons per layer are constants. The optimizer 603 stores the updated parameters to the parameter cache 902, and then the parameter cache 902 stores the updated parameters to the memory particles 901 to complete the update of the parameters.

The optimizer 603 may perform a stochastic gradient descent (SGD) method. According to the parameters, the learning rate in the constants, and the gradient, the stochastic gradient descent method uses derivatives in calculus to find a direction of function descent or the lowest point (extreme point) by finding a value of a function derivative. The weights are adjusted continuously based on the stochastic gradient descent method, so that a value of a loss function becomes smaller and smaller: in other words, a prediction error becomes smaller and smaller. A formula of the stochastic gradient descent method is as follows:

$${w}_{t} = {w}_{t - 1} - η \times g$$

wₜ₋₁ is a weight, n is a learning rate in the constants, g is a gradient, wₜ is an updated weight, a subscript t−1 refers to a current stage, and a subscript t is a next stage after one training, which refers to a stage after an update.

The optimizer 603 may also perform an AdaGrad algorithm based on the parameters, learning rate in the constants, and gradient. The idea of the AdaGrad algorithm is to adapt each parameter of the model independently: in other words, a parameter with a large derivative has a corresponding large learning rate, and a parameter with a small derivative has a corresponding small learning rate, and a learning rate of each parameter scales a square root of a sum of square values of historical gradients inversely proportional by each parameter. The formula is as follows:

$${m}_{t} = {m}_{t - 1} + {g}^{2}$$

$${w}_{t} = {w}_{t - 1} - η \times g \times {m}_{t}^{- \frac{1}{{2}^{}}}$$

wₜ₋₁ and mₜ₋₁ are parameters, n is a learning rate in the constants, g is a gradient, wₜ and mₜ are updated parameters, a subscript t−1 refers to a current stage, and a subscript t is a next stage after one training, which refers to a stage after an update.

The optimizer 603 may also perform an RMSProp algorithm based on the parameters, learning rate in the constants, attenuation rate
in the constants, and gradient. The RMSProp algorithm uses an exponential attenuation average to discard a distant history, which enables itself to converge quickly after finding a “convex” structure. Additionally, the RMSProp algorithm also introduces a hyperparameter (attenuation rate) to control a rate of attenuation. The formula is as follows:

$${m}_{t} = β \times {m}_{t - 1} + ( 1 - β ) \times {g}^{2}$$

$${w}_{t} = {w}_{t - 1} - η \times g \times {m}_{t}^{- \frac{1}{{2}^{}}}$$

wₜ₋₁ and mₜ₋₁ are parameters, n is a learning rate in the constants, β is an attenuation rate, g is a gradient, wₜ and mₜ are updated parameters, a subscript t−1 refers to a current stage, and a subscript t is a next stage after one training, which refers to a stage after an update.

The optimizer 603 may also perform an Adam algorithm based on the parameters, learning rate in the constants, attenuation rate in the constants, and gradient. Based on the RMSProp algorithm, in addition to adding an exponential attenuation average of a historical gradient square, the Adam algorithm further retains an exponential attenuation average of a historical gradient. The formula is as follows:

$${m}_{t} = {β}_{1} \times {m}_{t - 1} + ( 1 - {β}_{1} ) \times g$$

$${v}_{t} = {β}_{2} \times {v}_{t - 1} + ( 1 - {β}_{2} ) \times {g}^{2}$$

$${\hat{m}}_{t} = {m}_{t} / ( 1 - {β}_{1}^{t} )$$

$${\hat{v}}_{t} = {v}_{t} / ( 1 - {β}_{2}^{t} )$$

$${w}_{t} = {w}_{t - 1} - η \times {\hat{m}}_{t} \times {\hat{v}}_{t}^{- \frac{1}{{2}^{}}}$$

wₜ₋₁, mₜ₋₁ and vₜ₋₁ are parameters, n is a learning rate in the constants, β₁ and β₂ are attenuation rates in the constants, g is a gradient, wₜ, mₜ, and vₜ are updated parameters. A subscript t−1 refers to a current stage, a subscript t is a next stage after one training, which refers to a stage after an update, and a superscript t represents that t times of training are performed, so β^{t} refers to β to the t. \hat{m}ₜ and \hat{v}ₜ are momentums of momentums mₜ and vₜ after attenuation.

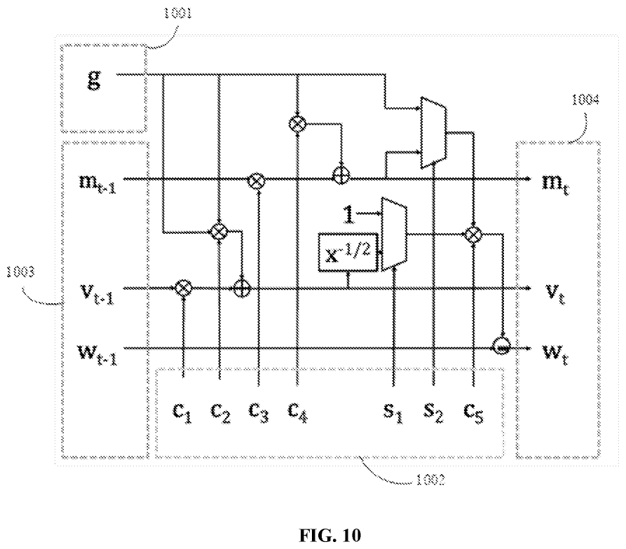

FIG. 10 is a schematic diagram of the optimizer 603. The optimizer 603 uses a simple adding circuit, subtracting circuit, multiplying circuit, and multiplexer to implement the above algorithms. After summarizing the above algorithms, the optimizer 603 is required to implement following operations:

$${m}_{t} = {c}_{1} \times {m}_{t - 1} + {c}_{2} \times g$$

$${v}_{t} = {c}_{3} \times {v}_{t - 1} + {c}_{4} \times {g}^{2}$$

$${t}_{1} = {m}_{t} or g$$

$${t}_{2} = {v}^{- \frac{1}{2}} or 1$$

$${w}_{t} = {w}_{t - 1} - {c}_{5} \times {t}_{1} \times {t}_{2}$$

In other words, any of the above algorithms may update parameters according to these operations, but each algorithm is paired with different constants. Take Adam algorithm as an example, and its constant configuration is as follows:

$${c}_{1} = {β}_{1}$$

$${c}_{2} = 1 - {β}_{1}$$

$${c}_{3} = {β}_{2}$$

$${c}_{4} = 1 - {β}_{2}$$

$${c}_{5} = η \frac{\sqrt{1 - {β}_{2}^{t}}}{1 - {β}_{1}^{t}}$$

$${s}_{1} = {s}_{2} = 1$$

According to a gradient 1001 and a constant 1002, the optimizer 603 updates a parameter 1003 into a parameter 1004 and then stores the parameter 1004 to the parameter cache 902.

During each training, parameters are fetched from the memory 601, quantized by the statistic quantization unit 602, stored in the WRAM 432 through the control of the quantization buffer controller 604, and then deduced by the operation unit 42 for forward propagation and back propagation to generate gradients, and the gradients are transferred to the optimizer 603 to perform the above algorithms to update the parameters. After one or more generations of training, the parameters are debugged, and at this point, the deep neural network model is now mature for prediction. In the inference phase, neuron data (such as image data) and trained weights are fetched from the memory 601, quantized by the statistic quantization unit 602, stored in the NRAM 431 and the WRAM 432 respectively through the control of the quantization buffer controller 604, and then computed by the operation unit 42. A computing result is quantized by the statistic quantization unit 602. Finally, the quantized computing result (which is a prediction result) is stored in the memory 601 to complete a prediction task of the neural network model.

The above embodiment provides a new mixed architecture, which includes an acceleration apparatus and a near data processing apparatus. Based on hardware-friendly quantization technique (HQT), statistic analysis and quantization are performed on the memory. Since there are the statistic quantization unit 602 and the quantization buffer controller 604, this embodiment implements the quantization of dynamic statistics, reduces unnecessary data access, and achieves the technical effect of high-precision parameter update, making the neural network model more accurate and lightweight. Moreover, since this embodiment introduces the near data processing apparatus, data may be quantized on the memory, and an error caused by quantizing long-tail distributed data may be directly suppressed.

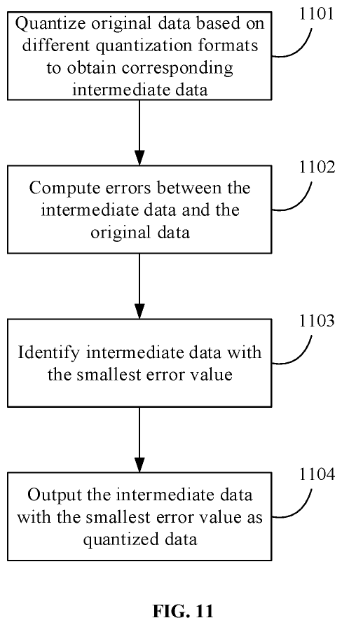

Another embodiment of the present disclosure shows a method for quantizing original data. FIG. 11 is a flowchart of performing the method using the statistic quantization unit shown in FIG. 7.

In a step 1101, original data is quantized based on different quantization formats to obtain corresponding intermediate data. The quantization components 704 receive input data from the buffer component of the buffer element 701 and quantize input data (also known as the original data) based on different quantization formats. Each quantization component 704 performs a different quantization operation and obtains different intermediate data according to a statistic parameter. The statistic parameter may be at least one of a maximum value of an absolute value of the original data, a cosine distance between the original data and corresponding intermediate data, and a vector distance between the original data and corresponding intermediate data.

In a step 1102, errors between the intermediate data and the original data are computed. The plurality of error computing units 706 receive the input data, intermediate data, and statistic parameters, and compute error values between the input data and the intermediate data. More specifically, each error computing unit 706 corresponds to one quantization component 704. Intermediate data generated by the quantization component 704 is output to a corresponding error computing unit 706, and the error computing unit 706 computes an error value between the intermediate data generated by the corresponding quantization component 704 and the input data. This error value represents a difference between quantized data generated by the quantization component 704 and input data before quantization, and the difference is compared with a statistic parameter cos(x, x′) from the statistic element 702 or x-x′. In addition to generating the error value, the error computing unit 706 also generates a label to record a quantization format of the corresponding quantization component 704; in other words, the label records that the error value is generated according to the kind of the quantization format.

In a step 1103, intermediate data with the smallest error value is identified. The selecting unit 707 receives error values of all error computing units 706, identifies the smallest of these error values by comparing these error values with the input data, and generates a control signal corresponding to the intermediate data with the smallest error value.

In a step 1104, the intermediate data with the smallest error value is output as quantized data. The first multiplexing unit 708 is configured to output the intermediate data with the smallest error value as output data according to the control signal; in other words, the control signal controls the first multiplexing unit 708 to output the intermediate data with the smallest error value in several quantization formats as the output data, which is the quantized data. The second multiplexing unit 709 is configured to output a label of the intermediate data with the smallest error value according to the control signal, where the label records a quantization format of the output data (the quantized data).

Another embodiment of the present disclosure shows a computer-readable storage medium, on which a computer program code for quantizing original data is stored, where when the computer program code is run by a processing apparatus, the method shown in FIG. 11 is performed. According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car: the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograma electronic device or apparatus of the present disclosure may also be applied to Internet, Internet of Things, data center, energy, transportation, public management, manufacturing, education, power grid, telecommunications, finance, retail, construction sites, medical, and other fields. Further, the electronic device or apparatus of the present disclosure may also be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It should be explained that for the sake of brevity, the present disclosure describes some method embodiments as a series of actions and combinations thereof, but those skilled in the art may understand that the solution of the present disclosure is not limited by the order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented in other ways that are not disclosed in the present disclosure. For example, for units in the aforementioned electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected to achieve the purpose of the solution described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like.

A1. A statistic quantization unit that quantizes a plurality of pieces of original data, including:
a buffer element configured to temporarily store the plurality of pieces of original data;
a statistic element configured to generate a statistic parameter according to the plurality of pieces of original data; and a quantization element configured to read the plurality of pieces of original data one by one from the buffer element according to the statistic parameter to generate quantized data.

A2. The statistic quantization unit of A1, where the buffer element includes a first buffer component and a second buffer component, the plurality of pieces of original data are temporarily stored to the first buffer component in sequence, and when a space of the first buffer component is filled, the plurality of pieces of original data are switched to be temporarily stored to the second buffer component in sequence.

A3. The statistic quantization unit of A2, where when the plurality of pieces of original data are temporarily stored to the second buffer component in sequence, the quantization element reads the plurality of pieces of original data from the first buffer component.

A4. The statistic quantization unit of A1, where the quantization element includes:
a plurality of quantization components, where each quantization component quantizes the original data based on different quantization formats, and the plurality of quantization components generate a plurality of pieces of intermediate data; and an error multiplexing component configured to select one of the plurality of pieces of intermediate data as the quantized data according to errors between the plurality of pieces of intermediate data and the original data.

A5. The statistic quantization unit of A4, where the plurality of quantization components implement the different quantization formats in a time-sharing manner.

A6. The statistic quantization unit of A5, where the statistic parameter is at least one of a maximum value of absolute values of the original data, a cosine distance between the original data and corresponding intermediate data, and a vector distance between the original data and corresponding intermediate data.

A7. The statistic quantization unit of A5, where the error multiplexing component includes:
an error computing unit configured to compute the errors between the plurality of pieces of intermediate data and the original data.
a selecting unit configured to generate a control signal, where the control signal corresponds to intermediate data with the smallest error value; and
a multiplexing unit configured to output the intermediate data with the smallest error value as the quantized data according to the control signal.

A8. The statistic quantization unit of A1, where the quantization element further generates a label, where the label is used to record a quantization format of the quantized data.

A9. The statistic quantization unit of A1, where the original data is neuron data or weights of a deep neural network.

A10. A storage apparatus, including the statistic quantization unit of any one of A1-A9.

A11. A processing apparatus, including the statistic quantization unit of any one of A1-A9.

A12. A board card, including the storage apparatus of A10 and the processing apparatus of A11.

B1. A quantization buffer controller connected to a direct memory access and a cache array, where data in the same quantization format is stored in a row of the cache array, and the quantization buffer controller includes a quantized data cache element and is configured to temporarily store quantized data and a label sent by the direct memory access, where the label records a quantization format of the quantized data.

B2. The quantization buffer controller of B1, further including:
a specific label cache element configured to temporarily store a specific label of a specific row of the cache array to which the quantized data is to be stored, where the specific label records a quantization format of the specific row; and
a quantization element configured to judge whether the label is the same as the specific label, where if the label is not the same as the specific label, the quantization format of the quantized data is adjusted as the quantization format of the specific row.

B3. The quantization buffer controller of B2, where the quantization element stores the adjusted quantized data to the specific row.

B4. The quantization buffer controller of B2, where the cache array includes M×N cache elements, and a length of the cache elements is S bits.

B5. The quantization buffer controller of B4, where the quantization buffer controller includes N quantization elements.

B6. The quantization buffer controller of B1, further including: a label cache configured to store a row label, where the row label records a quantization format of a row of the cache array.

B7. The quantization buffer controller of B1, where the cache array is configured to store neuron data or weights of a deep neural network.

B8. An integrated circuit apparatus, including the quantization buffer controller of any one of B1-B7.

B9. A board card, including the integrated circuit apparatus of B8.

C1. A memory for optimizing parameters of a deep neural network, including:
a plurality of memory particles configured to store the parameters;
a parameter cache configured to read and cache the parameters from the plurality of memory particles; and
an optimizer configured to read the parameters from the parameter cache and update the parameters according to a gradient, where
image data infers the deep neural network based on the updated parameters.

C2. The memory of C1, where the optimizer stores the updated parameters to the parameter cache, and the parameter cache stores the updated parameters to the plurality of memory particles.

C3. The memory of C1, where the gradient is obtained by training the deep neural network.

C4. The memory of C1, further including a constant cache configured to store constants, where the optimizer updates the parameters according to the constants.

C5. The memory of C4, where the optimizer performs a stochastic gradient descent (SGD) method according to the parameters, a learning rate in the constants, and the gradient to update the parameters.

C6. The memory of C4, where the optimizer performs an AdaGrad algorithm according to the parameters, a learning rate in the constants, and the gradient to update the parameters.

C7. The memory of C4, where the optimizer performs an RMSProp algorithm according to the parameters, a learning rate in the constants, an attenuation rate in the constants, and the gradient to update the parameters.

C8. The memory of C4, where the optimizer performs an Adam algorithm according to the parameters, a learning rate in the constants, an attenuation rate in the constants, and the gradient to update the parameters.

C9. An integrated circuit apparatus, including the memory of any one of C1-C8.

C10. A board card, including the integrated circuit apparatus of C9.

D1. An element for quantizing original data, including:
a plurality of quantization components configured to quantize the original data based on different quantization formats to obtain corresponding intermediate data; and
an error multiplexing component configured to determine corresponding errors according to the intermediate data and the original data and determine quantized data from the intermediate data according to the errors.

D2. The element of D1, where the plurality of quantization components quantize the original data according to a statistic parameter.

D3. The element of D2, where the statistic parameter is at least one of a maximum value of absolute values of the original data, a cosine distance between the original data and corresponding intermediate data, and a vector distance between the original data and corresponding intermediate data.

D4. The element of D1, where the error multiplexing component includes:
an error computing unit configured to compute the errors.
a selecting unit configured to generate a control signal, where the control signal corresponds to intermediate data with the smallest error value; and
a multiplexing unit configured to output the intermediate data with the smallest error value as the quantized data according to the control signal.

D5. An integrated circuit apparatus, including the element of any one of D1-D4.

D6. A board card, including the integrated circuit apparatus of D5.

D7. A method for quantizing original data, including:
quantizing the original data based on different quantization formats to obtain corresponding intermediate data;
computing errors between the intermediate data and the original data;
identifying intermediate data with the smallest error value; and
outputting the intermediate data with the smallest error value as quantized data.

D8. The method of D7, where a quantizing step quantizes the original data according to a statistic parameter.

D9. The method of D8, where the statistic parameter is at least one of a maximum value of absolute values of the original data, a cosine distance between the original data and corresponding intermediate data, and a vector distance between the original data and corresponding intermediate data.

D10. A computer-readable storage medium, on which a computer program code for quantizing original data is stored, where when the computer program code is run by a processing apparatus, the method of any one of D7-D9 is performed.

The embodiments of the present disclosure have been described in detail above. The present disclosure uses specific examples to explain principles and implementations of the present disclosure. The descriptions of the above embodiments are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

1. A processing system for optimizing parameters of a deep neural network, comprising:
a near data processing apparatus configured to store and quantize original data running on the deep neural network to generate quantized data; and
an acceleration apparatus configured to train the deep neural network based on the quantized data to generate and quantize a training result, wherein
the near data processing apparatus updates the parameters based on the quantized training result, and image data infers the deep neural network based on the updated parameters.

2. The processing system of claim 1, wherein the near data processing apparatus and the acceleration apparatus respectively comprise a statistic quantization unit, and the statistic quantization unit comprises:
a buffer element configured to temporarily store a plurality of pieces of input data, wherein the plurality of pieces of input data are the original data or the training result;
a statistic element configured to generate a statistic parameter according to the plurality of pieces of input data; and
a quantization element configured to read the plurality of pieces of input data one by one from the buffer element according to the statistic parameter to generate output data, wherein the output data is the quantized data or the quantized training result.

3. The processing system of claim 2, wherein the buffer element comprises a first buffer component and a second buffer component, the plurality of pieces of input data are temporarily stored to the first buffer component in sequence, and when a space of the first buffer component is filled, the plurality of pieces of input data are switched to be temporarily stored to the second buffer component in sequence.

4. The processing system of claim 3, wherein when the plurality of pieces of input data are temporarily stored to the second buffer component in sequence, the quantization element reads the plurality of pieces of input data from the first buffer component.

5. The processing system of claim 2, wherein the quantization element comprises:
a plurality of quantization components configured to quantize the original data based on different quantization formats to obtain corresponding intermediate data; and
an error multiplexing component configured to determine corresponding errors according to the intermediate data and the original data and determine the quantized data from the intermediate data according to the errors.

6. (canceled)

7. The processing system of claim 5, wherein the statistic parameter is at least one of a maximum value of absolute values of the input data, a cosine distance between the input data and the corresponding intermediate data, and a vector distance between the input data and the corresponding intermediate data.

8. The processing system of claim 5, wherein the error multiplexing component comprises:
an error computing unit configured to compute the errors;
a selecting unit configured to generate a control signal, wherein the control signal corresponds to intermediate data with the smallest error value; and
a multiplexing unit configured to output the intermediate data with the smallest error value as the output data according to the control signal.

9. The processing system of claim 2, wherein the quantization element further generates a label, wherein the label is used to record a quantization format of the output data.

10. The processing system of claim 9, wherein the acceleration apparatus comprises:
a cache array, wherein data in the same quantization format is stored in a row of the cache array;
a direct memory access configured to control the output data and the label to be stored to the cache array; and
a quantization buffer controller, which comprises a quantized data cache element and is configured to temporarily store the output data and the label sent by the direct memory access.

11. The processing system of claim 10, wherein the quantization buffer controller further comprises:
a specific label cache element configured to temporarily store a specific label of a specific row of the cache array to which the output data is to be stored, wherein the specific label records a quantization format of the specific row; and
a quantization element configured to judge whether the label is the same as the specific label, wherein if the label is not the same as the specific label, the quantization format of the output data is adjusted to the quantization format of the specific row.

12. The processing system of claim 11, wherein the quantization element stores the adjusted output data to the specific row.

13. The processing system of claim 11, wherein the cache array comprises M×N cache elements, and a length of the cache elements is S bits.

14. The processing system of claim 13, wherein the quantization buffer controller comprises N quantization elements.

15. The processing system of claim 10, wherein the quantization buffer controller further comprises a label cache configured to store a row label, wherein the row label records a quantization format of a row of the cache array.

16. The processing system of claim 1, wherein the near data processing apparatus comprises:
a plurality of memory particles configured to store the parameters;
a parameter cache configured to read and cache the parameters from the plurality of memory particles; and
an optimizer configured to read the parameters from the parameter cache and update the parameters according to a gradient.

17. The processing system of claim 16, wherein the optimizer stores the updated parameters to the parameter cache, and the parameter cache stores the updated parameters to the plurality of memory particles.

18. The processing system of claim 16, wherein the training result comprises the gradient.

19. The processing system of claim 16, wherein the near data processing apparatus further comprises a constant cache configured to store constants, wherein the optimizer updates the parameters according to the constants.

20. The processing system of claim 19, wherein the optimizer performs a stochastic gradient descent method according to the parameters, a learning rate in the constants, and the gradient, or performs an AdaGrad algorithm according to the parameters, the learning rate in the constants, and the gradient to update the parameters.

21. (canceled)

22. The processing system of claim 19, wherein the optimizer performs an RMSProp algorithm according to the parameters, a learning rate in the constants, an attenuation rate in the constants, and the gradient, or performs an Adam algorithm according to the parameters, the learning rate in the constants, the attenuation rate in the constants, and the gradient to update the parameters.

23. (canceled)

24. (canceled)

25. (canceled)
